(19) United States
(12) Patent Application Publication
(10) Pub. No.: US 2013/0342468 A1
(43) Pub. Date: Dec. 26, 2013

(54) METHOD FOR DETERMINING TOUCH LOCATION ON A TOUCH PANEL AND TOUCH PANEL MODULE

(71) Applicant: Gerben Hekstra, Chu-Nan (TW)

(72) Inventor: Gerben Hekstra, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/528,555

(22) Filed: Jun. 20, 2012

(51) Int. Cl. G06F 3/041

(52) U.S. Cl. 345/173

(57) ABSTRACT

The disclosure provides a method (70, 80) for determining a corrected touch location ([u, v]_{cor}) on a touch panel (1) comprising a plurality of sensors (10), the method comprising
obtaining (71, 81) a first estimate ([u, v]ₑₛₜ, 20) for a touch location, a touch location being defined as a location on said touch panel sensing a touch of an object like a finger or a stylus;
determining (74, 84a, 84b) a correction vector ([u_{cor}, v_{cor}]) by applying at least one predetermined mapping (E_{cor}), using the first estimate ([u, v]ₑₛₜ) as input for said mapping;
combining (75, 85) the first estimate ([u, v]ₑₛₜ) and the correction vector ([u_{cor}, v_{cor}]) to obtain the corrected touch location ([u, v]_{cor}).

### FIELD OF THE INVENTION

The disclosure relates to a method for determining a touch location on a capacitive touch panel, and to a touch panel module adapted to determine a touch location.

### BACKGROUND OF THE INVENTION

Capacitive touch panel devices are widely used to allow user interaction with electronic devices. In particular, a transparent touch panel can be used on top of a display device to allow a user to interact with the electronic device via a graphical user interface presented on the display device. Such touch panels are used in for example mobile phones, tablet computers, and other portable devices.

A known touch panel for use with such devices comprises a glass plate provided with a first electrode comprising a plurality of first sensing elements on one face of the glass plate, and a second electrode on an opposite face of the glass plate. The core operating principle is that the touch panel is provided with means for determining (changes in) the capacity between any of the first sensing elements of the first electrode and the second electrode. Such change in capacitance is attributed to a touch event, sometimes also called a gesture or touch gesture. By determining the location of the sensing element where the change in capacitance is maximized, the central location of the touch event is determined.

In coplanar touch panels the sensors are located in one single (Indium Tin Oxide, ITO) layer and each sensor has its own sense circuitry. Coplanar touch technology uses differential capacitance measurements in combination with a coplanar touch sensor panel. The sense circuit measures the charge that is required to load the intrinsic capacitance of each individual sensor and in addition (if applicable) the finger-touch-capacitance for those sensors that are covered/activated by the touch event. The intrinsic capacitance of the sensor depends on the sensor area, distance to a reference (voltage) layer and the dielectric constant of the materials between sensor and this reference layer. Assuming that the intrinsic capacitance is stable and constant over time, this is accounted for during the tuning/calibration procedure. The variation of sensor capacitance due to a touch event will then be the discriminating factor revealing where the touch is located.

The accuracy performance of a touch panel is the most important characteristic of the functionality of a touch panel as it shows the capability of recognizing a touch event on the same location as the actual spot location of the physical touch. Next to this, a high accuracy will improve the ability of determining the shape and size of the touch event. Moreover, a high spatial accuracy performance of a touch display will enable to correctly recognize stylus input (i.e. touches with a relative small impact diameter <4 mm).

In general, the accuracy of a touch panel with a fixed size will increase by enlarging the sensor density i.e. the total number of active touch sensors per display area. With a larger sensor density per area, not only the location, but also the shape and size of the touch can be detected with more accuracy. For a typical touch application of a pixelated display panel, (in which as a response of the touch event, part of the display will be activated/selected), the ultimate touch sensor dimension will be equal to the display pixel sensor or in other words: the maximum accuracy can be achieved when the touch sensor density is equal to the Pixels-Per-Inch (PPI) value of the display.

For various reasons, such as costs, design and process capability (track/gap capabilities) and display form factor (e.g. availability for track/routing layout) the number of I/O lines of the touch driver/controller will be limited. Consequently, the number of touch sensors of a touch panel of a display module will, in general, be much smaller than the actual number of display pixels which will have its negative impact on the achievable accuracy. Normally, for stylus input (i.e. with only a small area touching the surface, <4 mm diameter), a relatively higher accuracy is requested than for a finger input (with larger area touching the touch panel, i.e. 9 mm diameter). This is because a stylus input is related to typical touch display functionalities such as line drawing and hand-writing which requires a small spatial input (and recognition).

FIG. 3 illustrates a so-called “centroid” method in which known touch panel devices calculate the touch location based on the detected touch sensor values. A touch location is here defined as a location on a touch panel sensing a touch of an object like a finger or a stylus. FIG. 3 shows a part of a touch panel comprising sensors 10 arranged in a diamond shape. The panel is touched at touch location 21 (the center of the x-y coordinates used in FIG. 3) by an object having a touch spot area A indicated by the circle around central touch location 21. The values (or “counts”) detected by each capacitive sensor 10 are indicated with S₁, S₂, . . . S₉, and graphically represented in the form of an area. A larger area means a relatively higher count. The count is proportional to the part of area A that overlaps with the sensor cell. The 5th sensor measures the largest count (S₅), while neighbouring 4th, 8th, and 7th sensors measure decreasing values. The touch location [x, y] may be determined by evaluating the following formula:

$$[ x , y ] = \frac{{\sum }_{i} {S}_{i} \cdot {\overline{P}}_{i}}{{\sum }_{i} {S}_{i}} \qquad ( 1 )$$

In this formula, vector Pᵢ represents the center location [xᵢ,yᵢ] of the ith sensor. The calculated location [x, y] is thus a weighted average of the center locations [xᵢ,yᵢ], wherein the sensor counts are the weights. In the present example, the location indicated by 20 in FIG. 3 is calculated, which is a little below the true touch location 21. This is due to the fact that the distant center of cell 7, which does not actually overlap with touch spot A, effectively “drags” the estimated touch location down along the negative y-axis.

The centroid method thus gives an [x, y] location that has a theoretically higher resolution than the resolution of the sensor grid. However, the centroid method only gives an approximation of the true touch location. The direction and magnitude of the error varies depending on the true location. For example, if the sensor 10 is touched exactly in the middle, the centroid method will give an exact result. If the true touch location is off-center, there is a varying error.

This varying error is particularly evident when the user tracks or draws a straight line across the sensor panel, as illustrated in lines a through e of FIG. 4a. These straight lines a, b, c, d, and e are “translated” by the centroid method into the wobbly lines a′, b′, c′, d′ and e′ of FIG. 4b. In FIG. 4b, only the wobble inside a single sensor 10 is shown. However, as the sensors form a regular grid, the wobble will also be regularly repeated across the length of the drawn straight line a-e.

It is an object of the disclosure to provide a method and apparatus for determining a touch location that reduces this wobble effect.

### SUMMARY OF THE INVENTION

The disclosure provides a method for determining a touch location on a touch panel comprising a plurality of sensors, the method comprising obtaining a first estimate for the touch location, determining a correction vector by applying at least one predetermined mapping, using the first estimate as input for said mapping, and combining the first estimate and the correction vector to obtain corrected location values.

The first estimate may advantageously be a low-complexity method, such as weighted average or centroid method. The mapping is pre-determined to map results of the first estimate to a correction vector, so that the combination of a the first estimate vector and the correction vector yields a close approximation of the true touch location. Thereby, the “wobble error” of the estimation is effectively reduced or removed altogether. The pre-determined mapping may be dependent on the detected touch spot size, that is, different mappings are used for smaller or larger touching objects (e.g. stylus point, fingertip, etc).

Here a mapping is understood to be any function that takes a number of input variables (e.g. one or more coordinate components corresponding to a touch location) and outputs one or more variables (e.g. one or more components of a correction vector) depending on the input variables. A mapping can be implemented in many different ways. To name but a few: it can implemented in hardware, in software, or a combination of both. The mapping can be numerically evaluated or approximated by means of a polynomial approximation, a series expansion, a Fourier series, a function fitted to empirical data, or by a (interpolated) lookup table comprising empirical or modeled data. According to an embodiment of the disclosure, the mapping can be implemented as a two-dimensional mapping, taking an two-dimensional estimate vector as input and yielding a two-dimensional correction vector. The two-dimensional mapping can be implemented as a two-dimensional lookup table (LUT). The mapping could also take three input variables, where the third variable is the touch spot size, and yield two correction vector components as output variables dependent on the input estimation components and the spot size.

The mapping can also be implemented as a combination of two one-dimensional mappings, where a first one-dimensional mapping takes a first component of the estimate vector as input yielding a first component of the correction vector, and a second one-dimensional mapping takes a second component of the estimate vector as input yielding a second component of the correction vector. The one-dimensional mappings may be implemented as one-dimensional lookup tables (LUTs). The mapping could also take two input variables, one estimation component and the touch spot size, and return a correction vector component dependent on the estimation component and the spot size.

The disclosure also provides a location determination module arranged to perform the above described method. To that end, the module may comprise an estimator unit for generating a first location estimate. The module may comprise a processor for controlling the units and performing calculations. The module may comprise one or more evaluation units implementing the above described mappings.

The disclosure also provides a touch sensor system comprising a touch sensor panel having a plurality of sensors and a touch location determination module as described above. The module may be arranged to receive touch sensor measurement values from the touch sensor panel.

The disclosure further provides a computer program product storing a computer program adapted to, when run on a processor, perform a method as described above.

### BRIEF DESCRIPTION OF THE FIGURES

The disclosure will be further explained in reference to figures, wherein

FIG. 1 schematically shows a top view of an electronic device comprising a touch panel device according an embodiment of the disclosure;

FIGS. 2a-2c schematically show cross section of touch panel device variants according an embodiment of the disclosure;

FIG. 3 schematically illustrates the centroid method for determining a touch location on a touch panel;

FIGS. 4a and 4b schematically illustrate the wobble effect

FIGS. 5a-5e schematically illustrate a method for determining a touch location according to an embodiment of the disclosure for various forms of sensors;

FIGS. 6a-6b schematically illustrate correction functions used in a method according the disclosure;

FIGS. 7a-7b schematically illustrate a method for determining a touch location according to an embodiment of the disclosure;

FIG. 8 illustrates a touch location determination module according to an embodiment of the disclosure.

### DETAILED DESCRIPTION

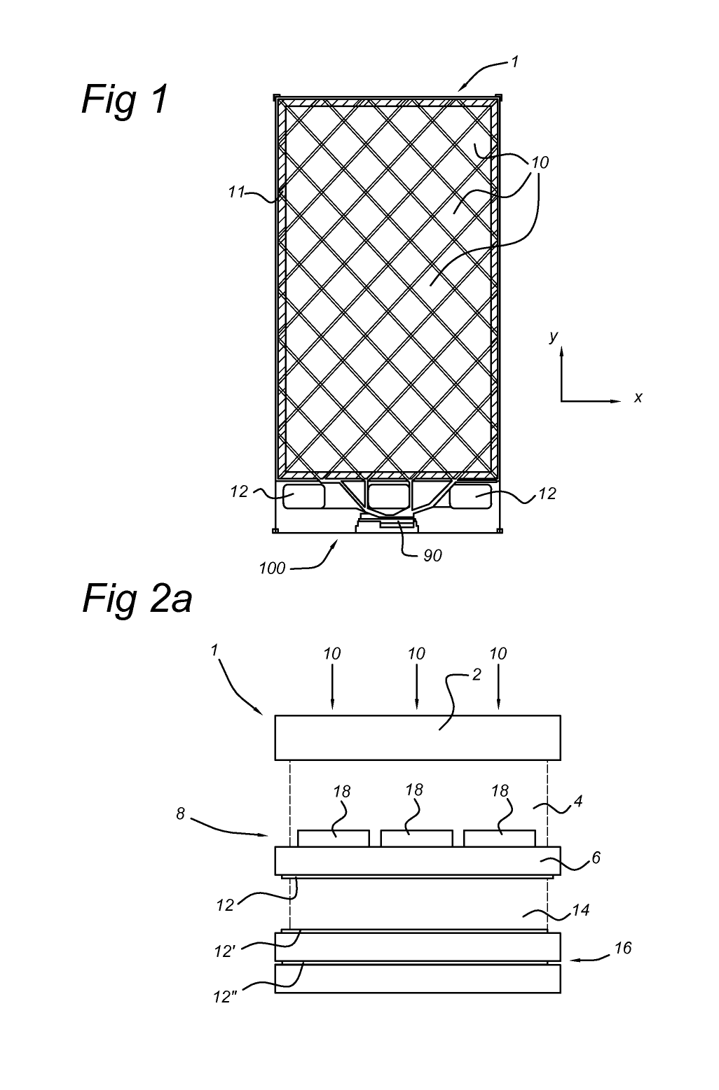

First, coplanar touch panels will be described in some more detail. FIG. 1 schematically shows a top view of an electronic device 100 comprising a coplanar capacitive touch panel device 1 and further user interface elements 12. Examples of applications with such devices are mobile telephones, tablet computers and other portable devices. In addition, display-less (input) devices such as mouse pads and graphics tablets. The touch panel 1 surface of the electronic device 100 can be optimized for finger touches and stylus touches.

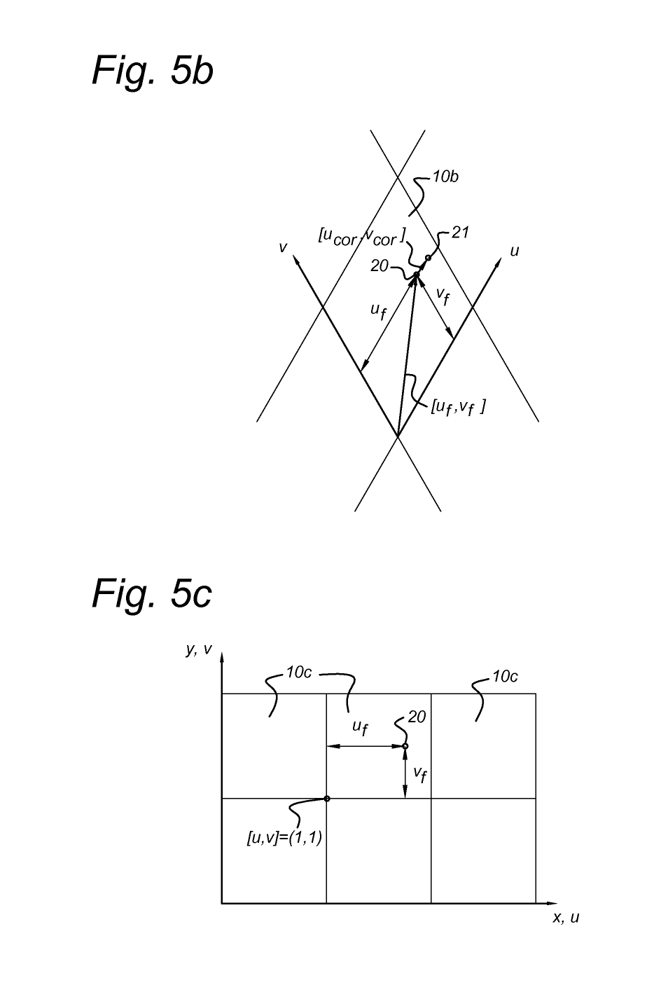

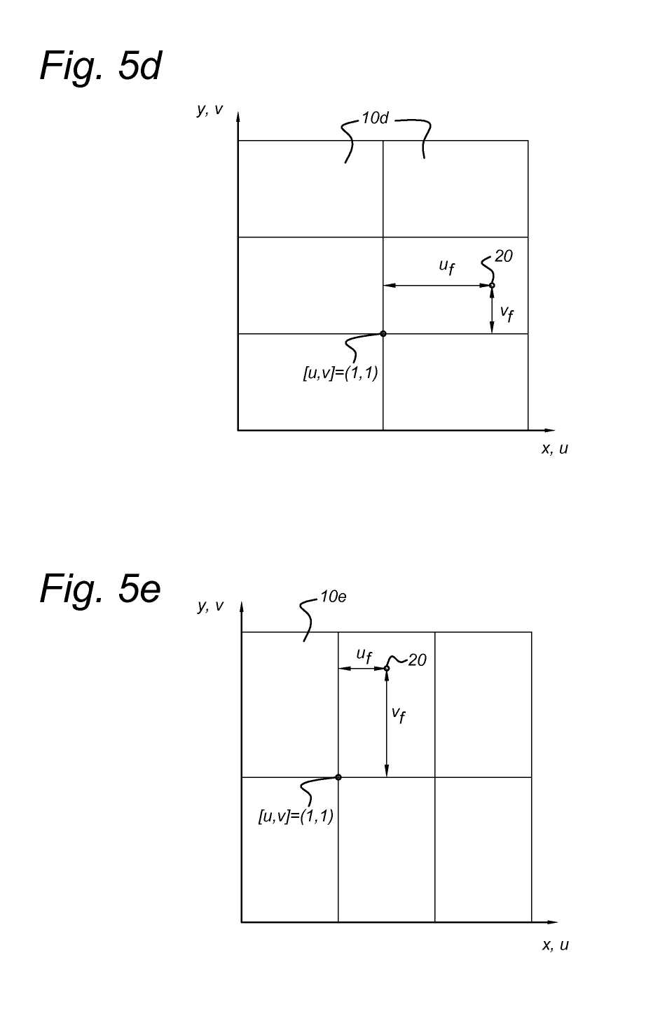

The touch panel surface is divided in a number of touch sensors 10. In the example of FIG. 1 the sensors 10 form a diamond pattern, but other patterns are possible as well (see for example FIGS. 5b-e). Each sensor 10 comprises a touch sensing element 18 (not shown in FIG. 1) which can be independently read by a location determination module 90.

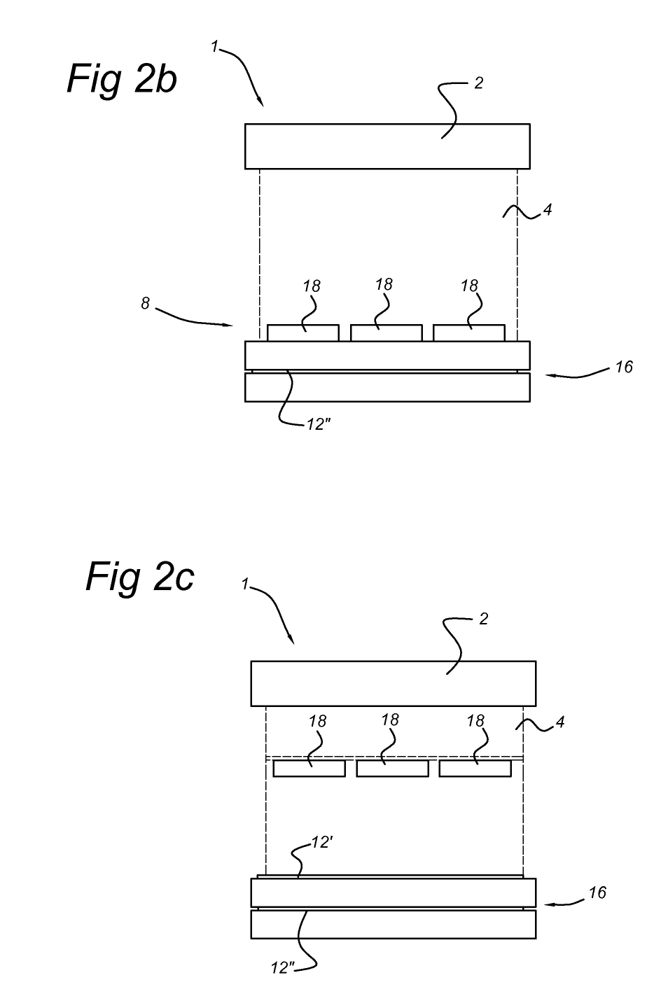

The touch panel surface is typically protected by a glass cover layer. For electronics devices comprising a display 16, the display is typically provided underneath the touch panel surface, however also variants exist in which display and touch panel layers are intermixed or shared. More details of the layers will be disclosed in reference to FIGS. 2a-2c below.

FIG. 2a schematically shows a cross section of a so-called “discrete co-planar touch” touch panel, while FIG. 2b shows an “on-cell co-planar touch” and FIG. 2c shows a “window integrated co-planar touch” touch panel configuration.

In FIG. 2a, the top layer is formed by transparent cover layer 2. This layer, which serves to protect the layers underneath from damage, is typically made of glass or another hard and transparent material in case the panel is used on top of a display layer 16. If no display is present (like in a mouse pad), a non-transparent protective layer may be used. In some cases, the glass cover layer is omitted, for example in order to reduce cost. In this case, the layer immediately below, which may for example be a polarizer layer, will serve as the cover layer 2 and as the surface that is to be touched by e.g. a finger or stylus. The term “cover layer” 2 thus does not necessarily refer to a glass top surface.

Beneath the cover window, sub-layer 4 is present. This layer can for example comprise an anti-splinter film to prevent the cover layer from falling apart into separate sharp pieces when broken. Sub-layer 4 can also be a polarizer layer, for example to work with display layer 16. Sub-layer 4 can also be formed of optical clear adhesive or simply an airgap (with double sided adhesive at the edges of the sensor).

Beneath sub-layer 4, the sensor layer 8 is located. This layer comprises separate touch sensing elements 18. The sensing elements 18 are provided on a substrate layer 6. Underneath the substrate layer 6 reference electrode layer 12 may be provided. Reference electrode layer 12 can provide a reference voltage. The touch sensing elements 18 can comprise Indium Tin Oxide (ITO), which is a suitable material for transparent sensors and tracks.

Beneath the substrate 6 to which the sensor layer 8 and reference electrode layer 12 are attached, another sub-layer 14 may be provided. This layer could again be an airgap, polarizer, adhesive layer, etc.

Below the sub-layer 14, the display layers 16 are provided. Such a display can for example be a Liquid Crystal Display (LCD) or organic light-emitting diode (OLED) display.

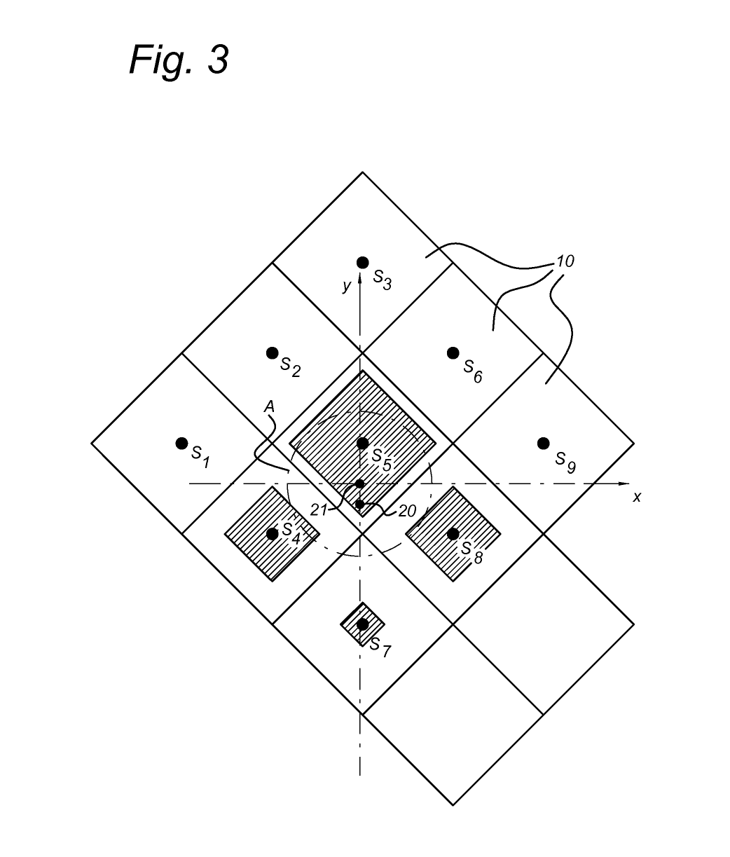

Instead of providing reference electrode layer 12 underneath the substrate 6, the reference voltage layer 12 may also be provided in other places of the stack, for example as a layer 12′ on top of the display 16 or as a layer 12″ inside the display stack 16. The function of the reference voltage layer 12, 12′, 12″ will be disclosed in reference to FIGS. 3a-3c. The reference voltage layer 12, 12′, 12″ can also be made of ITO.

As mentioned above, the display layer 16 may be absent, in which case the substrate 6 with reference electrode layer 12 and sensor layer 8, together with cover layer 2 forms a touch panel device, for example for use in mouse pads or graphics tablets.

FIG. 2b shows an alternative variant to the above described “discrete co-planar touch variant”, the “on-cell co-planar touch”. The main difference is that the sensor layer 8 comprising the touch sensing elements 18 is not provided on a separate substrate layer 6, but rather on the display layer 16. This saves an additional layer, and helps to reduce the size and production costs of the touch-panel display. In this case, the reference voltage layer is a layer 12″ in the display stack 16.

FIG. 2c shows a further variant, the “window integrated co-planar touch” variant. Reference is made to published US patent application 2010/0 097 344 A1 by the same applicant which details several embodiments of this variant. Again the separate substrate layer 6 is absent, and the sensor layer 8 is provided on one of the sub-layers 4, 14. The sub-layer 4 is not required—the sensing elements 18 of the sensor layer 8 could also be provided directly on the cover layer 2 (see for example FIG. 3c). The reference electrode layer 12′, 12″ is provided respectively on or inside the display stack 16.

It is noted that the above described exemplary touch panels comprise capacitive touch sensors. However, the disclosure is not limited to capacitive sensors. The disclosure may be applied to any local surface-integrating sensor, such as for example photosensitive touch sensors.

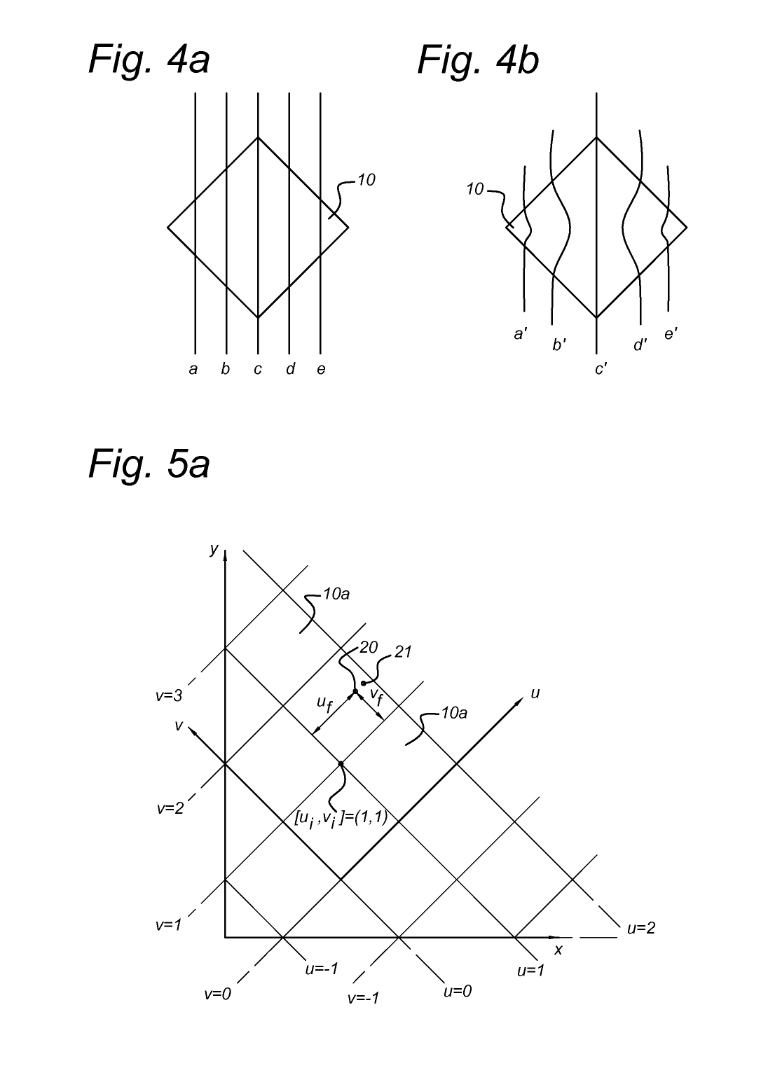

The basic centroid method, illustrated in FIG. 3, giving rise to the wobble problem illustrated in FIGS. 4a and 4b has already been described in the introduction. Next, aspects of a method according the disclosure will illustrated in reference to FIG. 5a.

FIG. 5a schematically shows a part of a touch sensor panel comprising sensors 10a having a diamond shape. The shown x- and y-axes are aligned with respective sides of the touch panel module. That is, location [x,y]=[0,0] corresponds with the bottom left corner. Also shown are axes u and v, which form the [u,v] coordinate system. The u and v axes are aligned with sides of the sensors 10. Moreover, the coordinates are normalized, so that sensor 10a boundaries correspond to lines where u or v has an integer value (see the illustrated lines u=0, u=1, v=0, etc).

Using the centroid method, or any other approximate method, a first estimate of the touch location 20 can be determined. If the centroid method is used, the first estimate can be calculated in the [x, y] coordinate system (as in equation (1)) and then be transformed to the corresponding [u, v] coordinates via an affine transformation determined by the pre-determined lay-out of the sensors 10a in the grid. Alternatively the centroid method can be adapted to calculate in the first estimate in [u, v] coordinates directly by expressing the sensor center locations Pᵢ in [u, v] coordinates.

The first estimate can then be split into an integer part [uᵢ, vᵢ] and a fractional part [u_{f}, v_{f}]. Since the [u, v] coordinates are normalized and aligned with the grid, the integer part [uᵢ, vᵢ] will point to a corner of the cell in which the estimated location 20 is located. The fraction part [u_{f}, v_{f}]. will point from that corner to the estimated location 20.

The true touch location is indicated by point 21 (the distance between points 20 and 21 is somewhat exaggerated in order to show more clearly the wobble effect). Between points 20 and 21 a correction vector [u_{cor}, v_{cor}] can be drawn, that is [u, v]ₜᵣᵤₑ=[u, v]ₑₛₜ+[u_{cor}, v_{cor}].

The error [uₑᵣᵣ, vₑᵣᵣ]=−[u_{cor}, v_{cor}] in the estimate is dependent on the relative location of the true location 21 with respect to the sensor 10a center. In other words, a function Eₑᵣᵣ(u_{f}, v_{f}) exists which will, for a given [u_{f}, v_{f}]ₜᵣᵤₑ coordinate, give the resulting estimate error [uₑᵣᵣ, vₑᵣᵣ]. The reverse of this function E_{cor}(u_{f}, v_{f}) can then be used to map a given estimate [u_{f}, v_{f}]ₑₛₜ to the [u_{cor}, v_{cor}]=−[uₑᵣᵣ, vₑᵣᵣ] value.

While the E_{cor}(u_{f}, v_{f}) may be derived analytically from first principles, it may be more efficient to determine the function empirically using for example a robot to systematically touch a panel in pre-determined “true” locations and analyzing the resulting estimated locations. In that manner, a two-dimensional (lookup) table (LUT) may be formed that provides the needed mapping from [u_{f}, v_{f}]ₑₛₜ to [u_{cor}, v_{cor}]

It is not necessary according to the disclosure to perform the calculations in the [u, v] coordinate system. It is also possible to perform the calculations and to generate the two-dimensional mapping in the [x, y] coordinates or any other coordinate system.

An advantage of the [u, v] coordinate system, or any coordinate system in which the axes are aligned with the borders of the sensors 10a-10e, is that the function is, to a high degree of accuracy, separable. That is, the needed correction in the u direction, u_{cor} is only dependent on u_{f}, and the correction v_{cor} in the v direction depends on v_{f}. Instead of using a two-dimensional mapping, two separated one-dimensional mappings may be used, u_{cor}=E_{cor,u}(u_{f}) and v_{cor}=E_{cor,v}(v_{f}).

If the sides of the sensors all have equal length (e.g. sensors 10a, 10b, and 10c in FIGS. 5a-5e) and the capacitive sensors 28 and other circuitry underneath also do not give rise to asymmetries in the sensors 10a, 10b, 10c, a single one-dimensional mapping can be used for both u_{cor} and v_{cor}, that is E_{cor,u}(x)=E_{cor,v}(x), where x is any number between 0 and 1.

FIGS. 5b-5e illustrate some other sensor arrangements that may be used in combination with the method as explained above. FIG. 5b shows a parallelogram sensor 10b configuration, in which the [u, v] coordinate system is not orthogonal. The method as described above may be applied for these sensors 10b as well. FIG. 5c shows a grid with square sensors 10c, and FIGS. 5d and 5e show rectangular sensors 10d, 10e, for which the disclosure may also be applied.

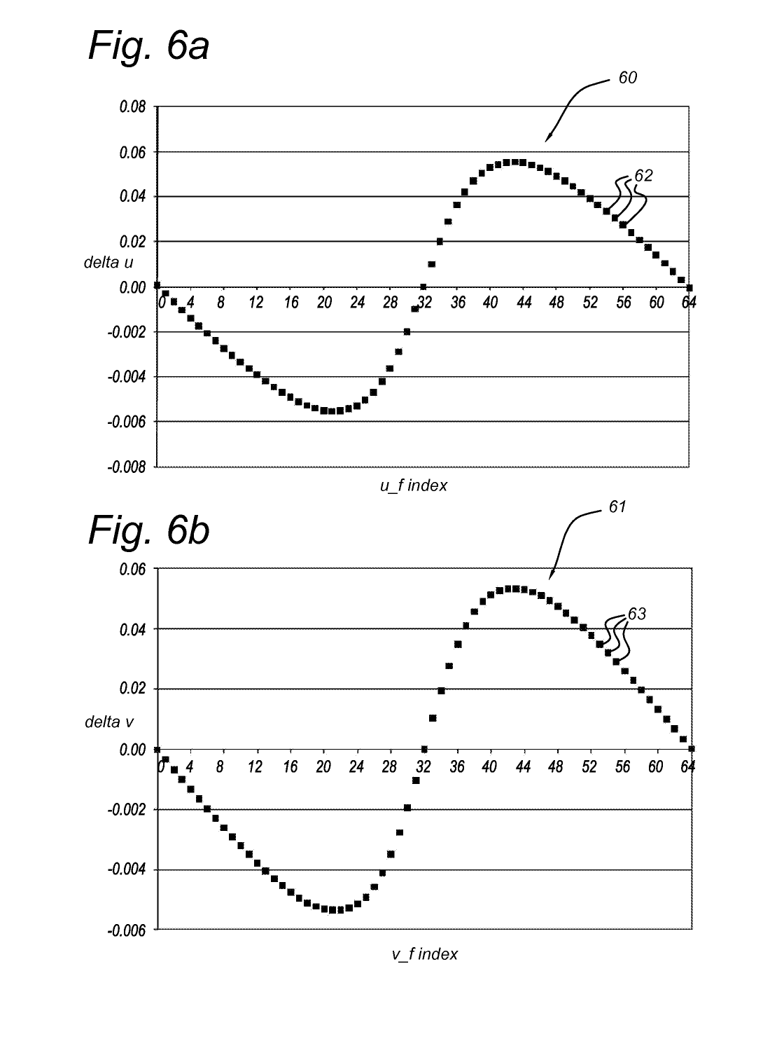

FIGS. 6a and 6b show exemplary graphs 60, 61 with values 62, 63 for the E_{cor,u}(u_{f}) and E_{cor,v}(v_{f}) mappings respectively. The x axis is indexed, that is in FIG. 6a, x=0 corresponds to u_{f}=0, and x=64 corresponds to u_{f}=1. The y axis gives the needed correction u_{cor} (in graph 60) and v_{cor} (in graph 61). At the center and in the corner points, the correction is 0, while in the intermediate areas the error (in absolute values) peaks.

There are many ways in which a skilled person may implement an evaluation means for evaluating the one-dimensional mappings illustrated in FIGS. 6a and 6b, or the two-dimensional mappings discussed above, either in [u,v] coordinates, [x,y] coordinates, or any other coordinate systems. Example evaluations means are processors, ICs, programmable logic ICs, etc, programmed or arranged to perform a indexing operation in an array (LUT), to evaluate a fit function, such as a polynomial or a Fourier series, fitted to pre-determined correction data. What is generally important is that the pre-determined correction data is reproduced based on the estimated location as input.

When the symmetry of the sensors allows it (as is the case in the example sensor geometries shown in FIGS. 5a-5e and in the example mappings shown in FIGS. 6a and 6b) folding can be used to more simply implement a evaluation means to evaluate the mappings E_{cor,u}(u_{f}) and E_{cor,v}(v_{f}). That is, an evaluation means may be made to evaluate the mapping E_{cor,u}(u_{f}) for u_{f}=[0 . . . 0.5] by using for example a lookup-table (LUT), a pre-programmed fit function, polynomial evaluation circuit, or any other suitable evaluation means so that the data points 0-32 of FIG. 6a are approximated. Then, for the values for u_{f}=[0.5 . . . 1] the mapping can be evaluated by using the symmetry, that is E_{cor,u}(u_{f})=E_{cor,u}(1-u_{f}) for u_{f}=[0.5 . . . 1]. This allows a more cost-efficient or more accurate implementation of E_{cor,u}. The same holds for E_{cor,v}.

The inventor has noted that the needed correction is generally dependent on the size A of the part of the touching object that makes contact with the touch panel (hereafter: the touch spot size A). It may therefore be advantageous to provide a plurality of mappings E_{cor,i} for various pre-determined touch spot sizes Aᵢ. For example, if E_{cor} mappings are made for spot sizes i=1, 4, and 9 mm², and a touch panel is touched by a object with spot size 6, the table for i=4 may be used (closest) or an interpolated value of the results using mappings E_{cor,Ai=4} and E_{cor,Ai=9} may be used.

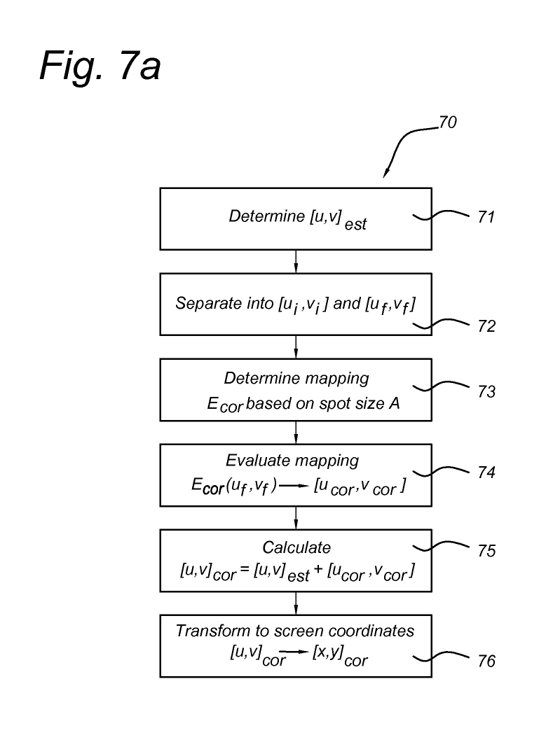

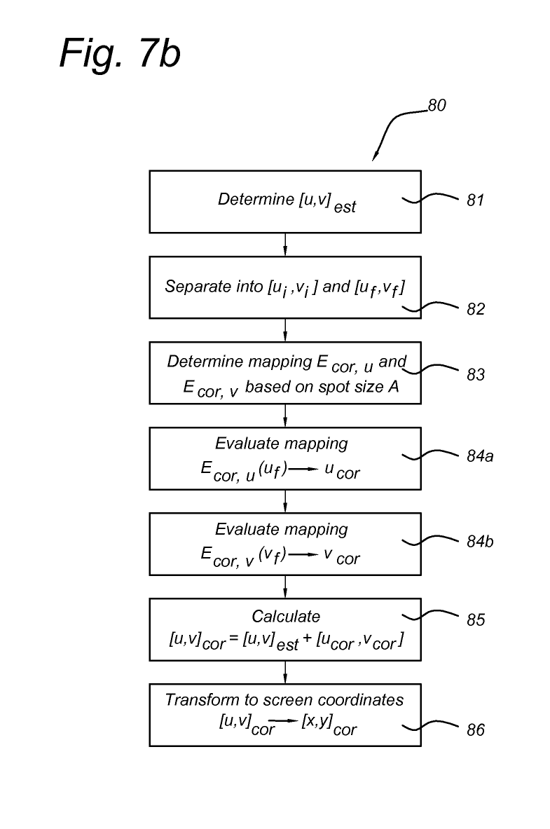

FIG. 7a illustrate an embodiments of a method 70 according to the disclosure. First, a[u,v[ₑₛₜ estimate is determined 71, which is separated into an integer part [uᵢ, vᵢ] and a fractional part [u_{f}, v_{f}] in action 72. In action 73, the spot size A is determined. This spot size may for example be estimated from the total sensor measurement, that is

$$A ∝ {\sum }_{i} {S}_{i} .$$

In action 74, a two-dimensional mapping is evaluated to obtain correction vector [u_{cor}, v_{cor}]. Then in action 75 the corrected touch location [u, v]_{cor} is calculated from u=uᵢ+u_{f}+u_{cor} and v=vᵢ+v_{f}+v_{cor}. Finally, the [u, v] values are transformed to the [x, y] coordinate system. For example, the [x, y] axes may be aligned with the sensor module boundaries and normalized so that an increment by one corresponds to a pixel increment.

FIG. 7b illustrates a further method 80 according to the disclosure. Actions 81, 82 correspond to actions 71, 72 in FIG. 7a. In action 73, the one dimensional evaluation functions E_{cor,u} and E_{cor,v} are selected based on the detection spot size. In case the symmetry of the sensors allows it (all sides having equal length) only a single E_{cor} function for both u_{f} and v_{f} needs to be selected. In actions 84a and 84b, u_{cor} and v_{cor} are determined by evaluating E_{cor,u} and E_{cor,v}. Actions 85 and 86 again correspond to actions 75 and 76 of FIG. 7a.

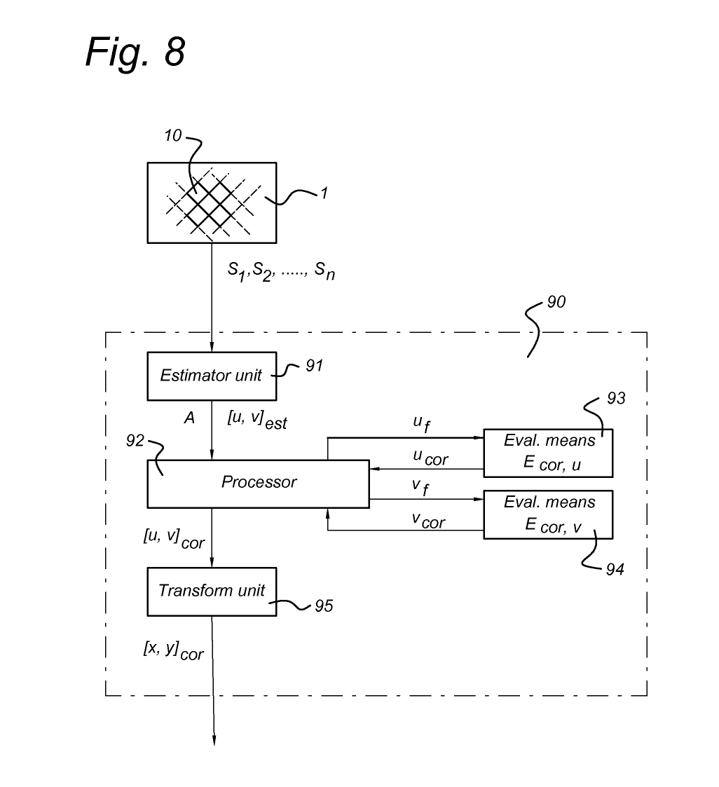

FIG. 8 schematically illustrates a location determination module 90 attached to a touch panel 1. The location determination module 90 and the touch panel 1 can form a touch panel device. The sensor values S₁, S₂, . . . Sₙ of n sensors are input into location estimation unit 91. The location estimation unit 91 generates a first estimate [u, v]est based on the sensor values, for example using the centroid method. A processor 92 receives the [u, v]est values from estimation unit 91. The estimation unit 91 may also provide an estimate of the touch spot size to the processor.

The processor then sends the u_{f}, v_{f} values to first evaluation means 93 and 94 respectively. Evaluation means 93 is arranged to calculate mapping value E_{cor,u}(u_{f}). The processor may also send the spot size to evaluation means 93, so that evaluation means 93 can select a suitable mapping, as outlined above. Alternatively, the processor means may implement a correction, for example interpolation as outline above, based on the results of one or more calculated mappings by evaluation means 93. Likewise, evaluation means 94 is arranged to calculate E_{cor,v}(v_{f}). Finally, the processor 92 calculates the corrected [u, v] values after which transformation unit 95 transforms the corrected [u, v] values into [x, y] coordinates.

It is observed that, in the above specification, at several locations reference is made to “evaluation means” or “processors”. It is to be understood that such evaluation means/processors may be designed in any desired technology, i.e. analogue or digital or a combination of both. A suitable implementation would be a software controlled processor where such software is stored in a suitable memory present in the touch panel device and connected to the processor/controller. The memory may be arranged as any known suitable form of RAM (random access memory) or ROM (read only memory), where such ROM may be any form of erasable ROM such as EEPROM (electrically erasable ROM). Parts of the software may be embedded. Parts of the software may be stored such as to be updatable e.g. wirelessly as controlled by a server transmitting updates regularly over the air.

The computer program product according the disclosure can comprise a a portable computer medium such as an optical or magnetic disc, solid state memory, a harddisk, etc. It can also comprise or be part of a server arranged to distribute software (applications) implementing parts of the disclosure to devices having a suitable touch panel for execution on a processor of said device.

It is to be understood that the disclosure is limited by the annexed claims and its technical equivalents only. In this document and in its claims, the verb “to comprise” and its conjugations are used in their non-limiting sense to mean that items following the word are included, without excluding items not specifically mentioned. In addition, reference to an element by the indefinite article “a” or “an” does not exclude the possibility that more than one of the element is present, unless the context clearly requires that there be one and only one of the elements. The indefinite article “a” or “an” thus usually means “at least one”.

1. Method (70, 80) for determining a corrected touch location ([u, v]_{cor}) on a touch panel (1) comprising a plurality of sensors (10), the method comprising
obtaining (71, 81) a first estimate ([u, v]ₑₛₜ, 20) for a touch location, a touch location being defined as a location on said touch panel sensing a touch of an object like a finger or a stylus;
determining (74, 84a, 84b) a correction vector ([u_{cor}, v_{cor}]) by applying at least one predetermined mapping (E_{cor}), using the first estimate ([u, v]ₑₛₜ) as input for said mapping;
combining (75, 85) the first estimate ([u, v]ₑₛₜ) and the correction vector ([u_{cor}, v_{cor}]) to obtain the corrected touch location ([u, v]_{cor}).

2. The method (70, 80) according to claim 1, further comprising selecting (73, 83) at least one predetermined mapping from a plurality of predetermined mappings based on a touch spot size (A).

3. The method (70, 80) according to claim 1, further comprising transforming (76, 86) the corrected location values ([u, v]_{cor}) to l t panel coordinates ([x, y]_{cor}).

4. The method (70, 80) according to claim 1, wherein the first estimate is obtained (71) by calculating a weighted average of sensor locations (Pᵢ) wherein the weights are determined by sensor measurements values (Sᵢ).

5. The method (70, 80) according to claim 1, further comprising
separating (72, 82) the first estimate ([u, v]ₑₛₜ) for the touch location in an integer part ([uᵢ, vᵢ]) and a fractional part ([u_{f}, v_{f}]), and using the fractional part ([u_{f}, v_{f}]) as input in the mapping (E_{cor}).

6. The method (70) according to claim 1, wherein the predetermined mapping is a two-dimensional lookup table, LUT.

7. The method (80) according to claim 1, wherein the correction vector is determined using two one-dimensional mappings, a first one-dimensional mapping (E_{cor,u}) for obtaining a first correction vector component (u_{cor}) using a first estimate component as input, and a second one-dimensional mapping (E_{cor,v}) for obtaining a second correction vector component (v_{cor}) using a second estimate component as input.

8. The method according to claim 5, wherein the correction vector is determined using two one-dimensional lookup tables, indexed by a first component (u_{f}) of the fractional part and a second component (v_{f}) of the fractional part respectively, to respectively obtain the first correction vector component (u_{cor}) and the second correction vector component (v_{cor}).

9. Touch location determination module (90) for a touch panel (1), the touch location determination unit (90) comprising
an estimator unit (91) arranged to obtaining a first estimate ([u, v]ₑₛₜ) for the touch location;
a mapping unit (93, 94) arranged to determine a correction vector (u_{cor}, v_{cor}) using at least one predetermined mapping (E_{cor}), using the first estimate ([u, v]ₑₛₜ) as input in said mapping;
a processor (92) arranged to combine the first estimate ([u, v]ₑₛₜ) and the correction vector ([u_{cor}, v_{cor}]) to obtain a corrected touch location ([u, v[_{cor})

10. The module (90) according to claim 9, wherein the mapping unit (93, 94) is arranged to select at least one predetermined mapping from a plurality of predetermined mappings based on a touch spot size (A).

11. The module (90) according to claim 9, further comprising a transform unit (95), arranged to transform the corrected location values ([u, v]_{cor}) to t a panel coordinates ([x, vy]_{cor}).

12. The module (90) according to claims 9, wherein the processor (92) is arranged to separate the first estimate ([u, v]ₑₛₜ) for the touch location in an integer part ([uᵢ, vᵢ]) and a fractional part ([u_{f}, v_{f}]).

13. The module (90) according to claim 12, wherein the mapping unit (93, 94) implements a two-dimensional lookup table, LUT, indexed by coordinates ([u_{f}, v_{f}]) of the fractional part to obtain the correction vector ([u_{cor}, v_{cor}]).

14. The module (90) according to claim 12, wherein a first mapping unit (93) is arranged to implement a first one-dimensional mapping (E_{cor,u}) for obtaining a first correction vector component (u_{cor}) using a first estimate component as input, and a second mapping unit (94) is arranged to implement a second one-dimensional mapping (E_{cor,v}) for obtaining a second correction vector component (v_{cor}) using a second estimate component as input.

15. The module (90) according to claim 14, wherein the first and second one-dimensional mappings (E_{cor,u}, E_{cor,v}) are implemented in the respective mapping units (93, 94) as one-dimensional lookup tables, indexed by a first component (u_{f}) of the fractional part and a second component (v_{f}) of the fractional part respectively, to respectively obtain the first correction vector component (u_{cor}) and the second correction vector component (v_{cor}).

16. Touch sensor system comprising a touch sensor panel (1) having a plurality of sensors (10) and a touch location determination module (90) according to claims 9, the module (90) arranged to receive touch sensor measurement values (S₁, S₂, . . . Sₙ) from the touch sensor panel (1).

17. Computer program product storing a computer program adapted to perform the method of the claim 1.
